(19) United States
(12) Patent Application Publication
(10) Pub. No.: US 2004/0123934 A1
(43) Pub. Date: Jul. 1, 2004

(54) Polyurethane coating process for carpet backing

(76) Inventors: Glen Hamrick, Tunnel Hill, GA (US); Paul Walker, Dalton, GA (US); Jerry Lindsay, Rocky Face, GA (US)

Correspondence Address: DOUGLAS T. JOHNSON, MILLER & MARTIN, 1000 VOLUNTEER BUILDING, 832 GEORGIA AVENUE, CHATTANOOGA, TN, 37402-2289, US

(21) Appl. No.: 10/625,212

(22) Filed: Jul. 23, 2003

Related U.S. Application Data
(63) Continuation-in-part of application No. PCT/US02/35391, filed on Nov. 5, 2002.
Application No. PCT/US02/35391 is a continuation-in-part of application No. 09/993,864, filed on Nov. 5, 2001, now abandoned.
(60) Provisional application No. 60/245,966, filed on Nov. 3, 2000.

(51) Int. Cl. B32B 31/26

(52) U.S. Cl. 156/72; 156/307.7

(57) ABSTRACT

A method for preparing carpet by using polyurethane foam to anneal secondary backing to a greige, comprising fibers attached to a primary backing. The polyurethane monomers are mixed just prior to application to the greige primary backing allowing the relatively low viscosity polyurethane to penetrate the fibers of the primary backing to aid in fiber lock. The polyurethane coated greige is then contacted with the secondary backing before complete polymerization to insure sufficient tack to hold the backings together. Sufficient water is applied through application of steam after the polyurethane components are applied to the greige to completely cure the polyurethane without a curing oven.

### RELATED APPLICATION DATA

The present application is a continuation-in-part of PCT/US02/35391 filed Nov. 5, 2002, which is a continuation-in-part of U.S. Ser. No. 09/993,864, pending, which in turn claims priority from U.S. Provisional Application Ser. No. 60/245,966 entitled POLYURETHANE COATING PROCESS FOR CARPET filed on Nov. 3, 2000, the entire specification of each being incorporated herein by reference.

### FIELD OF THE INVENTION

The present invention relates to improved methods for adhering secondary backing to tufted or woven carpeting employing polyurethane adhesive systems.

### BACKGROUND OF THE INVENTION

Polyurethanes are produced in four different principal forms including elastomers, coatings, flexible foams, and cross-linked foams. Polyurethane foams are produced by reacting isocyanate compounds with polyol compounds generally in the presence of catalysts, surfactants, and other auxiliary agents. At the start of polyurethane foam production, the reactive raw materials are held as liquids in large, stainless steel tanks. These tanks are equipped with agitators to keep the materials fluid. A metering device is attached to the tanks so that the appropriate amount of the reactive material can be pumped out. Generally, the ratio of polyol to isocyanate is about 1:2; and the ratio of components is strictly metered to control the characteristics of the resulting polymers. The reacting materials are then mixed and dispensed. Reaction between the isocyanate and the polyol, usually referred to as the gel reaction, leads to the formation of a polymer of high molecular weight. This reaction increases the viscosity of the mixture and generally contributes to cross-link formation. The second major reaction occurs between isocyanate and water. This reactive produces carbon dioxide gas which promotes foaming causing the volume of the urethane polymer to grow. In some instances, auxiliary blowing agents are added to further increase the volume of the polymer.

Both the gel and blow reactions occur in foams blown partially or totally with carbon dioxide gas. In order to obtain a good urethane foam structure, the gel and blow reactions must proceed simultaneously and at optimum balance rates. For example, if the carbon dioxide generation is too rapid in comparison with the gel reaction, the foam tends to collapse. Alternatively, if the gel reaction is too rapid in comparison with the blow reaction generating carbon dioxide, the rise of the foam will be restricted resulting in high density form. In practice, the balancing of these two reactions is controlled by the natures of catalysts and auxiliary agents used in the process.

It is customary in the carpet and rug industry to use various forms of filled and unfilled latex or polyurethane to coat the back of carpet. The coating is used to bond the face fibers to the primary backing and also thereby creating good tuft bind or fiber lock, to bond secondary backing material to the greige (fibers/primary backing). For example, carpets having attached polyurethane layers as backing are described in U.S. Pat. Nos. 3,755,212; 3,821,130; 3,862,879; 4,022,941; 4,515,646; 5,604,267; 5,908,701; and 6,299,715. A key property of the carpet produced by these methods is annealing strength, the force required to separate the secondary backing from the carpet. In order to achieve optimal annealing strength, the secondary backing must be in direct contact with the greige, and a sufficient amount of adhesive must be between the greige and the secondary backing to thoroughly wet the fibers. Another key property is, the fiber lock, which measures the force necessary to pull face fibers from the carpet.

The most widely used annealing adhesive is latex. Latex is typically applied by methods involving roll over flatbed or roll over roll processes. Regardless, of the method used, the greige is coated with an adhesive precoat of latex, and the secondary backing, also coated with latex, is married to the greige and cured.

Although, latex is a popular adhesive, carpet prepared from latex displays numerous shortcomings. For example, the strength and hydrolytic stability of latex is less than desired, and latex is less durable over time than alternative polymer systems such as PVC plastisol or polyurethane. Moreover, latex curing requires the evaporation of large amounts of water during cure, a process that is both expensive and energy intensive. To minimize the cost of latex adhesives, substantial quantities of filler material are added. The use of latex filler hinders the effective recycling of manufacturing remnants and used carpet at the end of its life cycle. Alternatively, polyurethane adhesives have been employed to form carpet with superior annealing strength and other desirable physical properties. However, despite the advantages of polyurethane, cost and technical problems have kept it from widespread use in the industry as a coating, and even more rarely as a flexible foam.

Attempts to replace latex with polyurethane have resulted in a variety of new problems, requiring modifications to the usual latex annealing process. One striking example is the difficulty associated with placing polyurethane onto a greige material, while maintaining the necessary adhesiveness to attach the second backing. After the pre-polymers have been mixed and polymerization begins polyurethane soon begins to lose its adhesive properties. In addition, because the blow reaction substantially increases the volume of the polyurethane layer, even small irregularities in the application of the polyurethane components to the greige may result in unacceptable variations in the depth of the resulting polyurethane foam layer.

Loss of adhesiveness is generally not a problem with the use of latex. Conventional latex maintains its adhesiveness and viscosity during processing, even into the curing oven. Following application of latex adhesive to both the greige and the secondary backing the two components are married and as a result of the latex properties, good temporary adherence of the secondary backing to the greige is observed. In the curing oven, the latex viscosity does not drop significantly as water is evaporated. Thus, the secondary backing satisfactorily adheres to the greige, and little dripping of latex from the bottom of the carpet to the oven is observed.

On the other hand, polyurethane application from bulk troughs, common in latex systems, is made very difficult due to premature polymerization in the delivery line. Typically, polyurethane is applied as “froth,” polymerized prior to application and dispensed on the primary or secondary backing before the upstream edge of a doctor blade. However, unless the manufacturer guards against premature polymerization the delivery line becomes clogged, thereby retarding the flow of polyurethane to the dispensing apparatus. In addition polyurethane begins to lose its adhesiveness soon after polymerization begins unless the manufacturer controls the polymerization rate by using heat sensitive catalysts or other chemical agents designed to maintain the viscosity of the polyurethane. Regardless of the manufacturer's attempts at controlling premature polymerization, the manufacturer has only a finite amount of time after the pre-polymers (polyol and isocyanate) have been mixed in which to apply the polyurethane and contact the greige to the backing before the polymer begins to lose its adhesive properties.

In an attempt to combat the rapid loss of adhesiveness manufacturers have applied one coating of polyurethane to the greige as fiber lock and a second coating of polyurethane just prior to contacting the secondary backing to insure sufficient adhesion between the backings. Even with the additional polyurethane, the slow advancement of most commercial carpet lines, and the inherent lack of adhesiveness associated with polyurethane, does not allow for the desired adherence between the greige and the secondary backing.

Curing the backing to the greige is also complicated because of the considerable decrease in viscosity of the polyurethane prior to cure. The viscosity of the polyurethane, and likewise its adhesiveness, may decrease to only 10% of its initial value prior to application of the secondary backing as the catalyzed polyurethane-forming reaction begins to exert its effect. The greatest decrease in viscosity is often exhibited over the temperature range of ambient to 70° C., where the polyurethane catalysts are not optimally active. As a result, if the initial adherence of the secondary backing to the greige is insufficient the secondary backing may separate during this period of low viscosity.

In an attempt to address the problems associated with the use of polyurethane several changes to the underlying process have been disclosed. For example, U.S. Pat. No. 6,264,775 offers the addition of various chemical thickening agents to the polyurethane to maintain viscosity and adhesiveness. Another process provides for the use of multiple applications of polyurethane to the primary backing prior to joining the secondary backing. See e.g., U.S. Pat. No. 6,299,715. Still another technique disclosed in U.S. Pat. No. 6,299,715, is the application of both polyurethane to the primary backing and another tacky composition to the secondary backing prior to joining the two backings. In U.S. Pat. No. 4,515,646, two of the present inventors even tried to use refrigerated isocyanate and polyol components without catalysts to prevent premature polymerization. None of these techniques have been favored over standard latex based carpet laminates, primarily due to the increased cost and complexity associated with building and using separate manufacturing lines to implement the new technologies, or the failure of the techniques to work in a production environment.

It would therefore be desirable to provide a polyurethane foam carpet annealing process requiring only a single application of the polyurethane, while providing acceptable fiber lock and annealing strength. It would also be desirable to provide a polyurethane annealing system which does not require excessive quantities of polyurethane to provide sufficient annealing strength. It would be beneficial to provide a polyurethane annealing system which does not require an oven for curing.

### SUMMARY OF INVENTION

The present invention pertains to a polyurethane carpet annealing system which discloses several unique advantages over the prior art. First it requires only a single application of polyurethane. The lower amount of polyurethane employed in a single application significantly decreases the weight of the carpet and decreases raw material costs. Second, the polyurethane is blown and cured at ambient temperature. The absence of an oven-curing step markedly decreases the time from application of the polyurethane to product roll-up. Third, the principal source of water for the blow reaction is from steam applied to the polyurethane ingredients after they have been dispersed upon the greige. Fourth, a vacuum or ultra sonic system may be employed prior to application of steam to increase the penetration of the polyurethane ingredients into the greige. The carpet produced by the process exhibits acceptable fiber lock and initial secondary backing adhesion without the use of large quantities of polyurethane and without the expensive heat curing step common in other annealing systems. In combination, the two advantages significantly increase the commercial utility of the product.

### BRIEF DESCRIPTION OF DRAWINGS

FIG. 1 illustrates a typical prior art latex-based carpet annealing process.

FIG. 2 illustrates a preferred dispensing apparatus for applying mixed polyurethane components to a film.

FIGS. 3a and 3b illustrate front and side views of a preferred construction of the dies used to dispense the polyurethane components onto the film.

FIG. 4 is an alternatively preferred dispensing apparatus for mixing and dispensing the polyurethane components onto the film.

FIG. 5 illustrates one embodiment of the present invention.

FIG. 6 illustrates a second embodiment of the present invention.

FIG. 7 illustrates a third embodiment of the present invention.

FIG. 8 illustrates a fourth embodiment of the present invention.

FIG. 9 illustrates a fifth embodiment of the present invention.

### DETAILED DESCRIPTION OF THE INVENTION

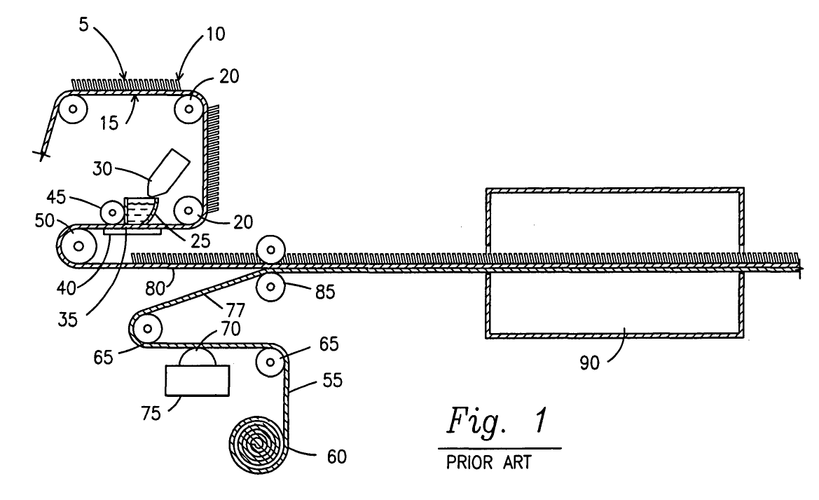

The present invention is designed to improve the annealing of secondary backing to tufted or woven carpeting utilizing a polyurethane adhesive system. Referring now to the drawings in more detail, FIG. 1 illustrates a typical prior art commercial latex-based carpet annealing process. The greige 5, with top carpet face 10 and bottom primary backing side 15 to which fiber lock adhesive is applied, is directed by rollers 20 to place the primary backing side 15 of the greige under trough 25, which is supplied with latex through line 30. The downstream edge of trough 25 serves as a doctor blade 35, in conjunction with plate 40. Adjusting the amount of latex applied also serves to force the latex through the primary backing 15 into the fibers. Further penetration is provided by pressure roller 45. The carpet is then redirected by roller 50. Secondary backing 55 is supplied from roll 60 and directed by rollers 65 across wheel-roll 70, which rotates in trough 75 filled with additional latex which coats the secondary backing 55. The coated secondary backing 77 is pressed onto the latex-coated greige 80 by their travel through ligation rolls 85. The carpet then passes through oven 90 where water is removed from the latex, and the latex cures, adhering fibers and secondary backing to form a lamellar carpet.

It will be understood that in most prior art polyurethane backings, water is not added to the froth and the resulting polyurethane backing is not “blown,” the only volume in the backing layer having been injected in the form of air in the froth. The present invention is directed to a flexible polyurethane foam that is blown, rather than merely a polyurethane coating.

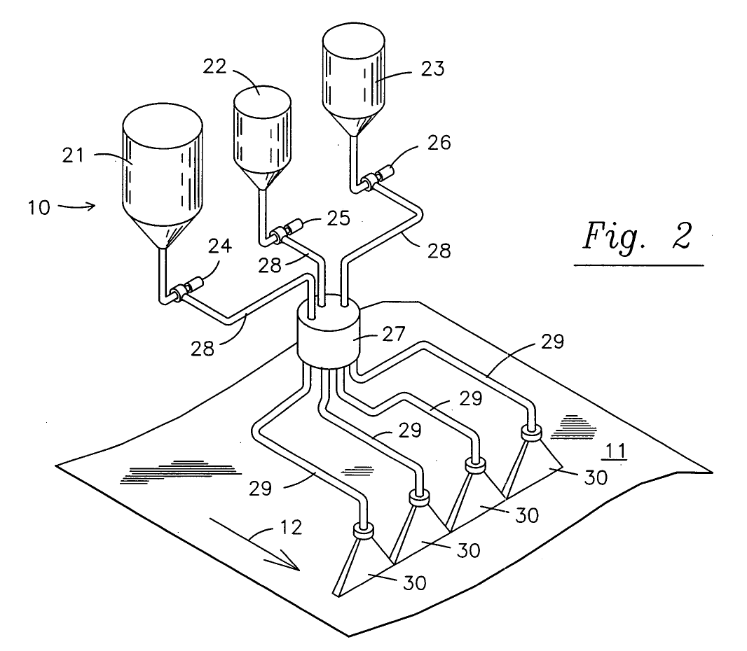

FIG. 2 illustrates a preferred dispensing apparatus for mixed polyurethane onto the greige. The greige 11, is fed in direction 12 past the dispensing apparatus 10. The dispensing apparatus 10 preferably comprises a polyol tank 21, iso tank 22, and catalyst tank 23. Polyol tank 21 contains polyol mixed with filler and surfactants, such as silicone. The iso tank 22 contains isocynate. The catalyst tank 23 contains one or more catalysts and a small amount of water. Typically, there will be between fifty and one hundred parts filler per hundred parts of polyol and between about 0.05 to 3.0 parts of water per hundred parts of polyol. Contents of polyol tank 21 are pumped by pump 24 through tube 28 to mix head 27. The temperature of the polyol mixture maybe controlled either by refrigerating the entire polyol tank 21 or by passing tube 28 through a heat exchanger to achieve the desired temperature prior to mixing. Similarly, the contents of iso tank 22 are pumped by iso pump 25 through tube 28 to mix head 27 and contents of catalyst tank 23 are pumped by pump 26 through another tube 28 to mix head 27. There may be an additional input line to mix head 27 for air or inert gas in order to increase the frothing of the mixture in mix head 27. All of the ingredients may be temperature controlled as described in connecting with the polyol mixture above. In addition. there may be other additives such as stabilizers, antioxidants, antimicrobials, anti-mildew agents, colorants, flame retardants, and chain extenders, all depending upon the characteristics desired in the resulting foam. The illustrated mix head 27 dispenses polyurethane mixture through outlet tubing 29 to a plurality of die heads 30 extending across a substantial width of the greige 11. In this embodiment, is anticipated that each individual die head 30 will be between about four and twelve inches in width, and preferably between about six to nine inches in width.

The pumps 24, 25, 26 precisely meter the constituent components of the polyurethane. Mix head 27 not only mixes and froths the components but also evenly controls the distribution of the polyurethane mixture to each of the die heads 30. After the mixture and frothing of the polyurethane components, outlet tubes 29 from the mix head 27 may also pass through heat exchanger apparatus to alter the viscosity and reaction time of the polyurethane.

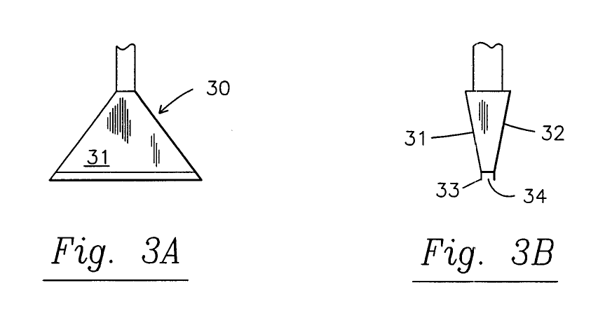

Back pressure helps keep the distribution from the material exiting the die heads 30 consistent and even across the width of the greige 11. The die head lips 33 shown in FIG. 3 may be adjusted depending upon the amount of polyurethane material to be applied. At least one of the die lips 33 can be permitted to touch the back of the greige 11, or both lips 33 may be raised to avoid contact with greige 11.

The adhesion of the polyurethane material to the greige 11 may be accomplished by the use of a roller, a doctor blade, controlled vacuum, ultrasonic waves or an air knife, and in some instances, by the viscosity of the polyurethane material. Penetration into the greige is critical to achieving acceptable tuft bond and annealing strength.

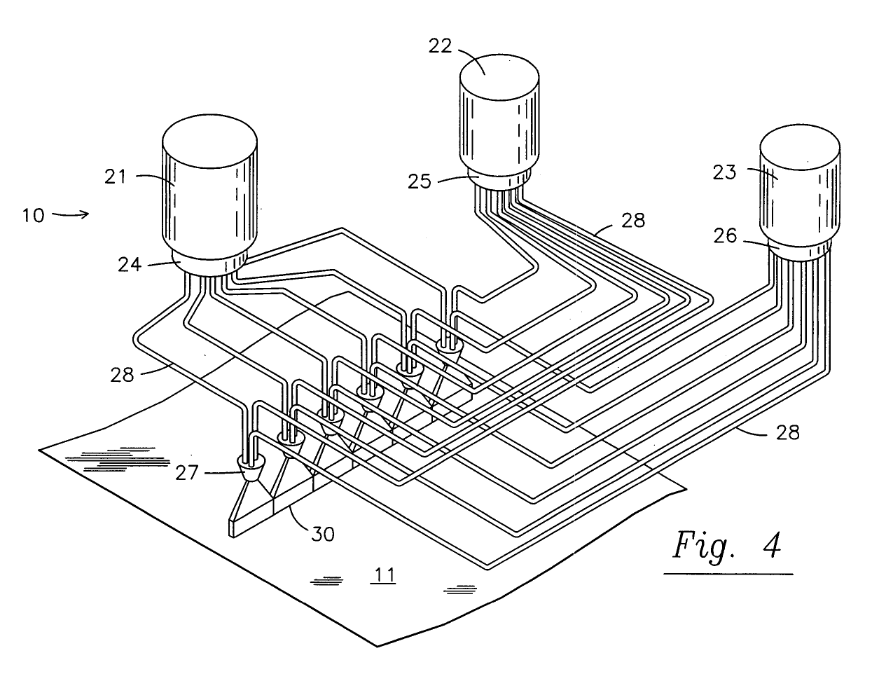

FIG. 4 illustrates an alternative embodiment for applying mixed polyurethane components to greige 11. In this instance, tanks 21, 22, 23, are associated with pumps 24, 25, 26 to convey the polyurethane components through inlet tubes 28 to a plurality of a small mix heads 27 that are substantially directly connected to die heads 30. This structure permits the polyurethane components to be blended and dispersed without passing through mix head outlet tubes 29, such as illustrated in FIG. 2. By placing the mix head 27 closer to the actual application of the polyurethane components, there is less time for a reaction to occur before the components are on the greige 11, thereby reducing the chance of clogging the dispensing apparatus. The modules of FIGS. 2 and 4 may be repeated across a wider film than illustrated, typically, up to approximately four or five meters in total width.

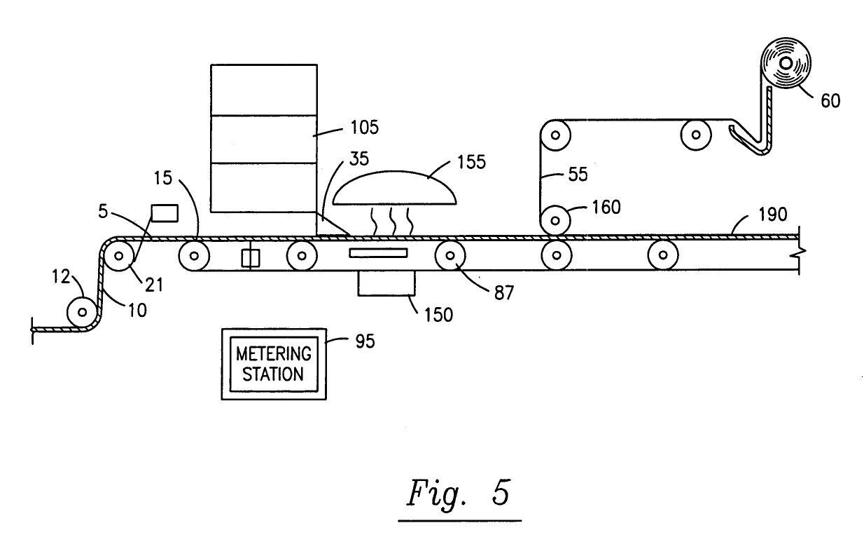

FIG. 5 illustrates the carpet manufacturing process according to the present invention. The greige 5 with carpet face 10 downward is fed onto a tenter roll 12 that directs the greige 5 to metering plate 95, the carpet face 10 is advanced over the metering plate 95 using pulling rollers 21.

In FIG. 5, a layer 100 of polyurethane polymer is deposited onto the primary backing side 15 as it passes over metering plate 95 using a mixing head 105. Preferably, the polyurethane is applied to the primary backing 15 at an area concentration of about 6 to 40 ounces per square yard or in a more preferred concentration of about 12 ounces per square yard.

In an even more preferred embodiment of the present invention, the polyol and isocyanate pre-polymer components are mechanically blown with catalyst, filler and other additives through a mixing head 105 to form the polyurethane layer 100. This prevents the pre-polymers from contact until just prior to application to the primary backing 15. At this time, only a small amount of water is added which reacts and serves as a blowing agent. According to this method, the polymerization process does not begin to occur until just prior to the exit of the polyurethane components from the mixing head 105. This process allows the relatively low viscosity polyurethane to deeply penetrate the fibers in the primary backing, resulting in excellent fiber lock characteristics.

After the polyurethane components are applied polymerization and foaming begins but at this time most of the volume of the polyurethane mixture is a result of frothing in the mix head. The thickness of the polyurethane foam may be adjusted by various means known in the art such as a doctor blade 35 or air knife. This is generally unnecessary, however, as the die heads 30 provide for a very even and controlled dispersal of polyurethane on the greige. The polyurethane coated greige 79 is then optionally passed across a steam box 150, that is adjustable with respect to steam temperature, volume, and slot size. Steam box 150 adds more water to facilitate the blow reaction and heat to aid in accelerating the gel reaction. In addition the steam serves to enhance blooming of the yarns passing through the primary backing for deeper penetration and assures a more level coverage of polyurethane. A fume hood 155 is placed above the steam box 150 to capture escaping volatiles released with the steam. Conspicuously absent at this stage of the process is an oven curing step. An oven is not necessary in the process because the polyurethane components are essentially kept separate until they are applied to the primary backing 15, therefore there is no need to dope the polyurethane components in order to control the rate of polymerization.

In a preferred embodiment of the present process temperatures are generally maintained within 30° F. of ambient temperature or in a more preferred embodiment within 15° F. of ambient temperature during the carpet manufacturing process. In contrast, prior art polyurethane curing processes are required to utilize heat sensitive catalysts and other chemical additives to maintain sufficient viscosities to apply the polyurethane, from various holding lines and troughs, to the backing surface. These additives, and the absence of water, necessitate a heat curing stage.

After applying the polyurethane coating, and steaming the coated greige 79, the coated greige 79 is rapidly pulled to merge roll 160 where the secondary backing 55, supplied from roll 60, contacts the coated greige 79 downstream from roller 87. Due to the short time that elapses between the initial application of polyurethane and the merger of the secondary backing 55 with the coated greige 79, the polyurethane possesses sufficient tackiness to anneal the secondary backing in place.

The merge roll 160 not only contacts the secondary backing 55 to the coated greige, but also serves to gauge the height of the blown polyurethane, preferably at no more than about one-eighth inch in height, and to halt any additional volumization of the polyurethane. This is due to the merge roll 160 compressing the blown polyurethane and rupturing many of the still closed cells within the polyurethane. In a preferred embodiment, the secondary backing is a spun bonded fabric of nylon, polypropylene, polyester, polyethylene or similar fibers and may have a calendared surface.

The independence gained by controlling the mixing of polyol and isocyanate has lead to the removal of a curing station. The excision of this step has dramatically improved the processing speed of laminated carpets, cutting manufacturing time by as much as 50-60% without sacrificing the annealing strength or fiber lock properties of the carpet. The annealed carpet can then be cooled briefly 190 and rolled for storage and transport.

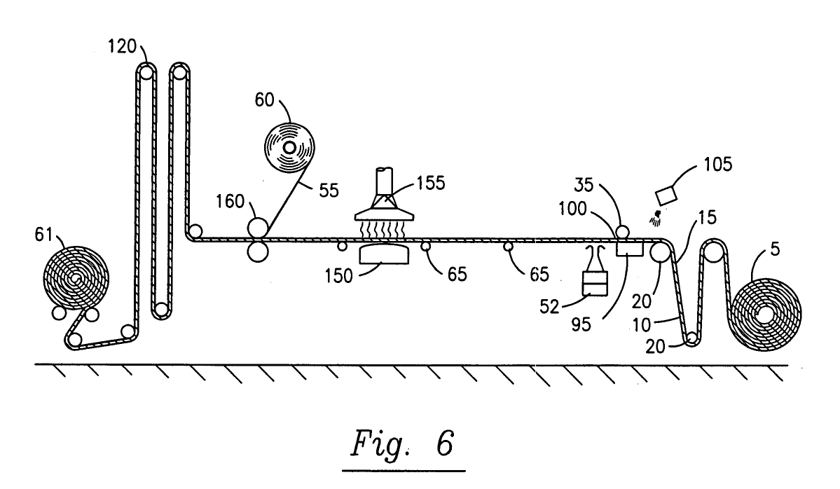

FIG. 6 illustrates an alternative carpet manufacturing process according to the present invention. The greige 5 with carpet face 10 downward is fed to metering plate 95. Polyurethane is sprayed from mixing head 105 onto the primary backing side 15. A doctor blade 35 or air knife insures that the sprayed polyurethane is not excessively puddled and the resulting primary backing has a relatively even layer of polyurethane 100. The carpet may at this point be fed over a vacuum 152 or ultra sonic wave device in order to pull the viscous polyurethane deeper into the primary carpet backing. Then the carpet continues across steam box 150 and fume hood 155 which adds water to the blow reaction. The heat from the steam box also accelerates polymerization and provides the additional benefit of enhancing blooming of the face yarns on the carpet. Again, oven curing is not necessary. Then a backing roll 60 feeds secondary backing 55 downward to merge roller 160 where the secondary backing is applied to the still curing and tacky polyurethane film layer 100. In the event the polyurethane film has cured sufficiently to lose much of its tackiness, the secondary backing 55 may require coating to enhance its adherence to the product. As in FIG. 5, the polyurethane polymer layer 100 is preferably applied to the primary backing 15 at an area concentration of about 6 to 40 ounces per square yard or in a more preferred concentration of about 12 ounces per square yard. In an even more preferred embodiment of the invention, the polyol and the isocyanate prepolymer components are mechanically blown through the mixing head 105 with water and other additives in a fashion that prevents the prepolymers from contact until immediately prior to application of the primary backing. In addition, in order to further retard the polymerization process until the polyurethane components reach the primary backing, refrigeration of the prepolymers may be employed.

The action of the merge roller 160 after the secondary backing is applied tends to crush the now polyurethane foam layer 100. Crushing, by rupturing many of the still closed cells within the film effectively stops the expansion of the film backing and permits curing to continue without substantially increasing the volume of the polyurethane layer 100. The film backed carpet is then fed through accumulator rolls 120 as curing is completed and is finally wound on a take-up roll in a finished state, typically in lengths of up to about 600 feet.

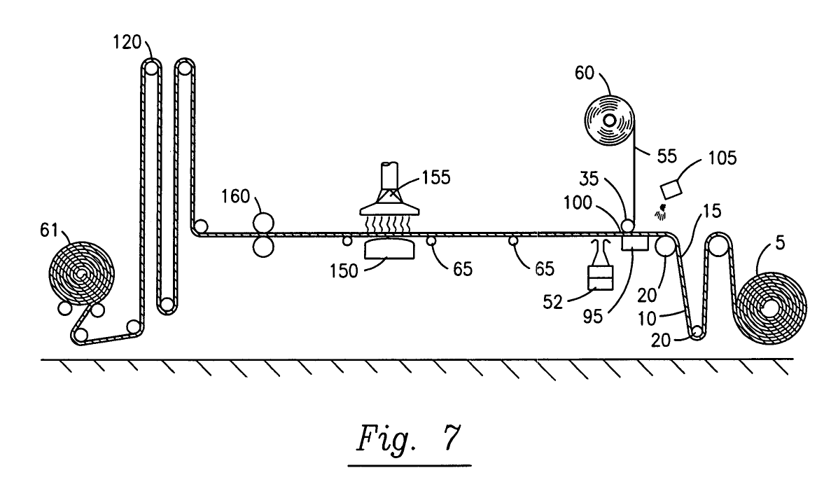

FIG. 7 is an illustration substantially of the polyurethane film backing line of FIG. 6, however in this configuration, the secondary backing 55 is applied at a much earlier stage in the process. In fact, immediately after the polyurethane polymer layer 100 is deposited on the backing side 15 of the greige as it passes over metering blade 95, the secondary backing 55 is applied, preferably by transition around a doctor bar 35 which causes the secondary backing 55 to come into contact with the polyurethane polymer layer 100 as the reaction of the prepolymers and water is just beginning. Advancing the secondary backing 55 around the doctor bar 35 provides the additional benefit of keeping the doctor bar 35 clear from any accumulations of polyurethane. The polyurethane polymer layer 100 begins its reaction between the primary backing side 15 and the secondary backing 55 and the use of steam box 150 and fume hood 155 accelerates this process and provides additional water to the reaction. Again passing under merge roller 160 crushes the backing and effectively halts the foaming process so that the polyurethane layer does not gain additional height. The curing process is completed as the carpet passes through accumulator 120 and is finally wound on a master carpet roll.

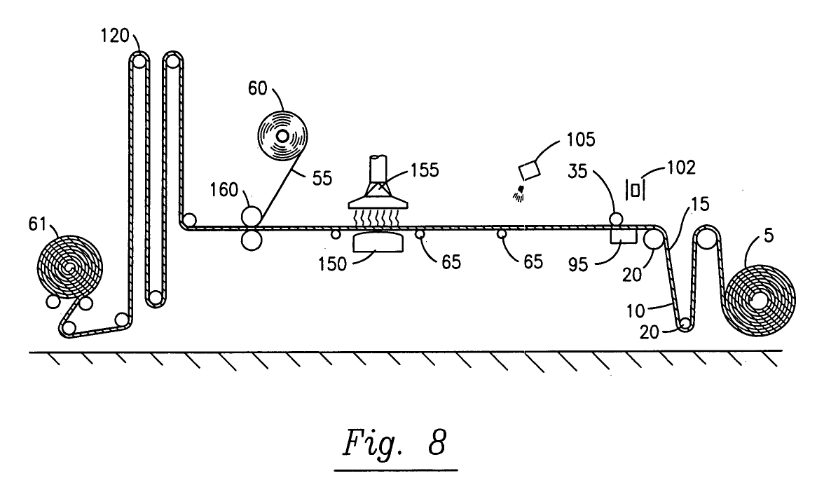

FIG. 8 illustrates another variation of the present invention in which the polyol and catalyst is mixed and applied in a puddle or froth onto the primary backing side 15 of the greige 5 over metering plate 95. Doctor bar 35 or air knife or other suitable means are utilized to insure even and controlled amounts of polyol, water and catalyst. As the greige proceeds through the line, one or more spray heads 105 dispense the isocyanate prepolymer component onto the prepolymer layer of polyol and catalyst. This permits the initiation of the polymerization process and the use of steam box 150 and fume hood 155 provides additional water to optimize blowing and foaming and accelerates the polymerization process. Secondary backing 55 is then applied and merging roll 160 crushes the film layer of both ensuring a complete adherence of the secondary backing to the polyurethane layer and stopping increased volumization of the polyurethane film layer. The backed carpet then passes through accumulator 120 to complete its curing and is then wound on to a master roll. It will be understood that a vacuum may be added to the configuration of FIG. 8 either after the metering plate 95 or after the spray head 105 to help insure that the polyurethane polymer is drawn sufficiently into the primary backing.

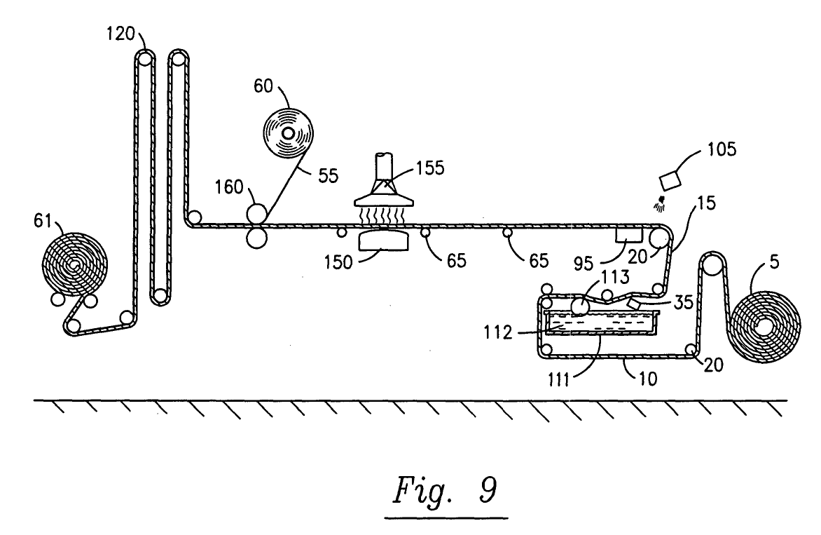

Yet another variation of the present invention involves passing the primary backing side 15 of the greige 5 over a foam pan 111 containing polyol, water and catalysts, the mixture being denominated 112 in FIG. 9. Wetting roller 113 carries a film of polyol, water and catalysts mixture 112 to the primary backing side 15 of greige 5 and doctor bar 35 facilitates even application. Once the primary backing side 15 is again upward facing, spray head 105 dispenses isocyanate so that polymerization may begin. Passing the layer of polyurethane polymer over steam box 150 and fume hood 155 provides more water for the reaction and heat to acceleration the polymerization. Again the secondary vacuum 55 is applied and merge roller 160 crushes the foam back ensuring contact between the secondary backing and the polyurethane polymer layer and halting the increased volumization of the foam layer. The carpet completes its curing as it passes through accumulator 120 and wound onto the master roll.

In all of the foregoing embodiments, the Figures have been simplified for clarity and to ease viewing and understanding. In commercial embodiments, additional devices, e.g. drive motors, tension devices, etc. will be required.

Polyurethane prepolymers useful in the practice of the present invention are prepared by the reaction of active hydrogen compounds with any amount of isocyanate in a stoichiometric excess relative to active hydrogen material.

The prepolymer formulations of the present invention include a polyol component. Active hydrogen containing compounds most commonly used in polyurethane production are those compounds having at least two hydroxyl groups or amine groups. However, any active hydrogen containing compound can be used with the present invention, and indeed some soy based oils can be used.

In the practice of the present invention, preferably at least 50 weight percent of the active hydrogen compounds used to prepare the polyurethane is a polyol having molecular weight of from about 100-400.

The polyisocyanate component of the formulations of the present invention can be prepared using any organic polyisocyanates, modified polyisocyanates, isocyanate based prepolymers and mixtures thereof. These can include aliphatic or aromatic isocyanates. Preferably the isocyanate used to prepare the prepolymer formulation of the present invention is methyl diisocyanates such as Bayer's 142L or Dow p901 or blends of equal type.

Catalysts suitable for use in preparing the polyurethane of the present invention include tertiary amines, and organometallic compounds and mixtures thereof. For example, suitable catalysts include stannous octoate, triethylenediamine, N-methyl morpholine, like compounds and mixtures thereof. The catalysts do not necessarily need elevated activation temperatures or other promoters to initiate polymerization.

Surfactants can be useful for preparing a stable dispersion of the present invention. Surfactants useful for preparing a stable dispersion can be cationic, anionic, or non-ionic surfactants. Preferably the surfactants used to prepare the prepolymer formulation of the present invention are silicone surfactants such as Dow Corning DC-194 or Union Carbide's L-540. A surfactant can be included in a formulation of the present invention in an amount ranging from about 0.01 to about 7 parts per 100 parts by weight of polyurethane component.

A compound of the present invention optionally includes a filler material. The filler material can include conventional fillers such as milled glass, calcium carbonate, aluminum trihydrate, barium sulfate, fly ash, dyes and pigments or fire retardants (aluminum trihydrate and Tris polyolefin glycol). Preferably the filler can be present in an amount ranging from 0 to 300 parts, and more preferably between 100 and 250 parts, per 100 parts of the polyurethane component.

Generally, any method known to one skilled in the art of preparing polyurethane froths can be used in the practice of the present invention to prepare a polyurethane froth suitable for preparing a carpet of the present invention, however, typically only one of the prepolymer mixtures is frothed, since the use of water as a blowing agent provides ample volume to the polyurethane. It is also possible to froth the polyurethane mixture in the mix head by adding air or inert gas at that point.

Although a preferred embodiment of the present invention has been disclosed herein, it will be understood that various substitutions and modifications may be made to the disclosed embodiment described herein without departing from the scope and spirit of the present invention as recited in the appended claims.

What is claimed is:

1. A method for preparing carpet utilizing a polyurethane foam to anneal a secondary backing to a greige, having fibers attached to a primary backing, said process comprising:
(a) preparing polyurethane by introducing polyol from a first dedicated line and isocynate from a second dedicated line into a mixing head with a filler, a catalyst, and a gas to froth the ingredients;
(b) directing the frothed ingredients to a die head;
(c) applying said polyurethane ingredients to form a coating on greige;
(d) evening the distribution of the polyurethane ingredients substantially across the width of the greige;
(e) applying steam to the polyurethane coated greige to increase gel and blow reactions;
(f) contacting a secondary backing to the polyurethane; and
(g) passing the polyurethane coated greige through a gauging device to level the blown polyurethane.

2. The method of claim 1 wherein water is added to the ingredients in the mixing head at a rate of less than 3.0 parts per 100 parts of polyol.

3. The method of claim 1 wherein the polyurethane foam has a weight of between about 6 ounces to about 40 ounces per square yard.

4. The method of claim 1 wherein a filler is added to the mixing head at a rate of less than 250 parts of filler to 100 parts of polyol.

5. The method of claim 1 wherein the distribution of polyurethane ingredients substantially across the width of the greige is accomplished by use of at least one of a doctor blade, a roller, or an air knife.

6. The method of claim 1 wherein the temperatures of the polyol and isocynate are controlled before entering the mix head.

7. The method of claim 1 wherein the mixing head is adjacent to the die head.

8. The method of claim 1 wherein the mixing head is connected to a plurality of die heads by relatively short connecting tubes.

9. The method of claim 8 wherein the short connecting tubes pass through a heat exchanger to alter the viscosity of the frothed ingredients.

10. The method of claim 1 wherein a dispensing opening of the die head is adjustable.

11. The process of claim 1 wherein said greige is subjected to steam after both coating with polyurethane and contact with the secondary backing.

12. The process of claim 1 wherein filler is present in the polyurethane in a concentration of from about 0 to about 300 parts per 100 parts of polyol.

13. The process of claim 1 wherein metallic or organic amine catalysts or a mixture thereof are introduced through a third dedicated line into said mixing head.

14. The process of claim 1 wherein a thermal rise of less than 30° F. is observed.

15. The process of claim 1 wherein said polyurethane foam applied to said primary backing is flame retardant.

16. The process of claim 1 wherein said polyurethane applied to said primary backing contains 0.5 to 3 parts water per 100 parts of polyol.

17. A method for preparing carpet by annealing a secondary backing to a greige, having face fibers extending from a first side of a primary backing, said process comprising:
a) preparing polyurethane by introducing polyol from a first dedicated line and an isocyanate from a second dedicated line into a mixing head application through a die;
b) applying said polyurethane to a second opposed side of the primary backing of said greige to form a tacky polyurethane-coated greige;
c) applying steam to the polyurethane coated primary backing; and
d) contacting said secondary backing with the polyurethane-coated greige to form a carpet.

18. The process of claim 17 wherein said polyurethane is applied to said primary backing at an area concentration of about 6 to about 40 ounces per square yard

19. The process of claim 17 wherein the filler is present in said polyurethane at a concentration of from about 0 to about 300 parts per 100 parts of polyol.

20. The process of claim 17 wherein metallic or amine catalysts or a mixture thereof are introduced through a third dedicated line into said mixing head for spray application.

21. The process of claim 17 wherein a thermal rise of less than 30° F. is observed.

22. The process of claim 17 wherein said polyurethane applied to said primary backing is flame retardant.

23. The process of claim 17 wherein said polyurethane applied to said primary backing contains 0.5 to 3 parts water per 100 parts of polyol.

24. A method for preparing carpet by annealing a secondary backing to a greige, having fibers attached to a primary backing, said process comprising:
a) preparing polyurethane by mixing a polyol component and an isocyanate component at about the same time the components are introduced into a mixing head for application through a die;
b) applying said polyurethane at ambient temperature to the primary backing side of said greige to form a tacky polyurethane-coated greige;
c) applying steam to the polyurethane coated primary backing; and
d) contacting said secondary backing with the polyurethane-coated greige to form a carpet.

25. The process of claim 24 wherein said polyurethane is applied to said primary backing at an area concentration of about 6 to about 40 ounces per square yard.

26. The process of claim 24 wherein the filler is present at a concentration of from about 0 to about 300 parts per 100 parts of polyurethane.

27. The process of claim 24 wherein metallic or amine catalysts or a mixture thereof are introduced into said mixing head for spray application.

28. The method of claim 1 wherein a thermal rise of less than 30° F. is observed.

29. The method of claim 1 wherein the secondary backing is a spun bonded fabric.
